(19) United States
(12) Patent Application Publication
(10) Pub. No.: US 2024/0156144 A1
(43) Pub. Date: May 16, 2024

(54) Trunnion Monitoring For Food Processing/Water Treatment

(71) Applicant: Lyco Manufacturing Inc., Columbus, WI (US)

(72) Inventors: Luke A. Titel, Deforest, WI (US); Daniel D. Maupin, Corvallis, OR (US); Steven J. Schultz, Beaver Dam, WI (US)

(73) Assignee: Lyco Manufacturing Inc., Columbus, WI (US)

(21) Appl. No.: 18/385,313

(22) Filed: Oct. 30, 2023

Related U.S. Application Data
(60) Provisional application No. 63/425,086, filed on Nov. 14, 2022.

(51) Int. Cl. A23N 12/04; B01D 33/11; B01D 33/80

(52) U.S. Cl. CPC A23N 12/04; B01D 33/11; B01D 33/804

(57) ABSTRACT

A method and apparatus for food processing includes a processing compartment, two trunnions, a sensor and an alarm. The processing compartment includes a rotating component having two ends. Each trunnion includes a component for rotational movement and the trunnions are disposed to support one of the ends. The sensor is disposed to sense a rotational speed of one of the components for rotational movement and the alarm is responsive to the sensor.

### FIELD OF TUE INVENTION

The present disclosure relates generally to the art of food processing and water treatment equipment. More specifically, it relates to monitoring trunnions used on food processing and water treatment equipment.

### BACKGROUND OF TUE INVENTION

Some well known types of food processing equipment include rotary components. For example, some blanchers, cookers or coolers include a drum that rotates, and others include an auger that rotates inside a stationary drum. One example of a rotating drum blancher is found in U.S. Pat. No. 7,500,426, hereby incorporated by reference. The drum is supported by trunnions and includes an auger that turns with the drum.

Prior art screw blanchers have typically included a shaft driven auger that is turned and supported by shafts with trunnions at each end. Some prior art food blanchers include an auger covered by a perforated screen (forming a cylindrical shape). The auger/screen assembly is disposed in a tank and typically sits above (six inches, e.g.) the tank bottom. One such prior art blancher is the Lyco™ 800 Rotary Drum Blancher. Other prior art rotary drum blanchers are described in U.S. Pat. Nos. 6,234,066, 6,187,360, 10,709,161, 8,191,466, 10,112,785, 10,143,209, 10,085,477, all of which are hereby incorporated by reference. Product is discharged using a discharge mechanism. Prior art discharge mechanisms can be seen in U.S. Pat. Nos. 7,735,415 and 5,341,729, both of which are hereby incorporated by reference.

One prior art system for filtering food processing waste water applies the water to a rotating cylindrical-shaped screen (a drum). The fluid to be filtered can be introduced to the inside of the drum. The drum is oriented horizontally, and the drum rotates. The screen filters the fluid. The cleaned fluid passes out of the lower surface, and the suspended solids/food product is trapped on the screen inside the drum. The solids must be removed from the interior of the drum. This is an internally fed design. Another known design is an externally fed screen drum, where the fluid is introduced to the top or sides of the cylindrical surface of rotating and horizontal oriented drum. The fluid passes through the screen to the interior of the drum. Solids are caught on the outside of the screen drum. Scrapers are used to scrape the solids off the outside of the drum. The partially filtered water (now inside the drum) passes through the lower part of the cylindrical screen surface, and is filtered again. In both designs the drum can be supported by trunnions.

Trunnions support a wide variety of food processing equipment, including rotary drums, augers, and food processing waster water treatment systems, and provide smooth rotation for the drum, auger, etc. Failure of the trunnion can lead to equipment malfunction and possibly catastrophic failure. For safety reasons, trunnions are normally well guarded to prevent pinch points or entrapment hazards. Some operators fail to grease trunnions, which means they can fail within months. Failures include the trunnion material itself, bearings, or shafts, resulting in the machine to fail due to metal to metal contact or overloading drive components. The non-normal wear can result in catastrophic failure requiring considerable downtime and the need to make special parts, and the machine is not operable during that time.

Prior art systems include a visual window to determine if trunnions are rotating. However, maintenance personnel and operators can easily overlook warning signs. Thus, it is often difficult to determine if the trunnion is operating properly, starting to fail, or completely stalled.

Other prior art systems create an alarm when the trunnion has stopped. However, such systems only provide warning when it is too late—the line must be shut down until the repair is made.

Accordingly, a food processing or food processing water treatment system that provides a warning that a trunnion is not operating properly and/or is beginning to fail is desirable. This would allow repairs to be performed during scheduled maintenance and allow for ordering of parts in advance.

### SUMMARY OF THE PRESENT INVENTION

According to a first aspect of the disclosure a food processing system includes a processing compartment, two trunnions, a sensor and an alarm. The processing compartment includes a rotating component having two ends. Each trunnion includes a component for rotational movement and the trunnions are disposed to support one of the ends. The sensor is disposed to sense a rotational speed of one of the components for rotational movement and the alarm is responsive to the sensor.

According to a second aspect of the disclosure a method of processing food includes providing food product to a processing compartment that includes a rotating component having two ends and supporting the ends with trunnions having components for rotational movement. The trunnions rotate at an intended rotational speed. The actual rotational speed is sensed and an alarm is provided in response to the actual rotational speed indicating a malfunction of a trunnion.

A second sensor is disposed to sense a rotational speed of the other component for rotational movement and the alarm is responsive to the second sensor in one alternative.

An alarm module includes an intended rotational speed one of the trunnions, and the alarm is part of the alarm module, and the alarm is responsive to a function of the intended rotational speed and to the first sensor in another alternative.

The alarm includes a visual indicator in one embodiment.

The alarm can include a communications module connected to a network, and the visual indicator includes at least one of a light and a digital message, in various embodiments.

The alarm can include a communications module connected to a remote location in one alternative.

The first sensor includes a flag on the component for rotational movement and a stationary mating pickup in another alternative.

The first sensor includes an encoder in one embodiment.

There are trunnions including components for rotational movement disposed to support the second end, each with a sensor to sense the rotational speed of the components for rotational movement, and the alarm is responsive to the sensors in various embodiments.

Other principal features and advantages of will become apparent to those skilled in the art upon review of the following drawings, the detailed description and the appended claims.

### BRIEF DESCRIPTION OF TUE DRAWINGS

FIG. 1 is perspective view of a food processing system in accordance with a preferred embodiment;

FIG. 2 is a perspective view of a screen that is a rotating component of the food product water treatment of FIG. 1;

FIG. 3 is an end view of trunnions used to support and rotate a first end of the screen of FIG. 2;

FIG. 4 is an end view of trunnions used to support and rotate a second end of the screen of FIG. 2;

FIG. 5 is a side view of the trunnions of FIGS. 3 and 4, and a control panel used in the preferred embodiment;

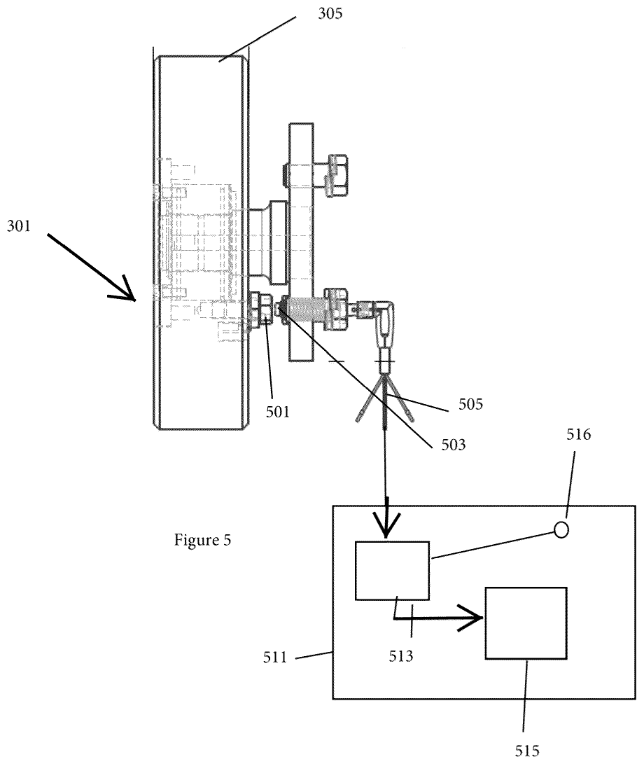

FIG. 6 is an alarm module used in the control panel of FIG. 5; and

FIG. 7 is a communications module used in the control panel of FIG. 5; and

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF TUE PREFERRED EMBODIMENTS

While the present disclosure will be illustrated with reference to a particular food processing system that is a treatment system for food processing waste water, it should be understood at the outset that the trunnion monitoring disclosed herein can be used with other food product processing systems. Food processing system, as used herein, is a system for cooking, cooling, blanching, screening, treatment of food processing waste water, etc., and includes rotary drums systems and auger systems.

The food processing system in accordance with the preferred embodiment is a food processing water treatment system. Generally, the food processing system can be in accordance with the prior art, except that it includes monitoring for one or more trunnions, and an alarm to indicate the operational status of the trunnion. Trunnion, as used herein, refers to a structure such as a ring, wheels, pin, shaft or pivot on which the position of a trunnion ring or shaft can be adjusted relative to a tank, and includes the cradle or support structure for the pin or pivot. Trunnions include a component for rotational movement, such as a wheel, shaft, ring, etc. Component for rotational movement of a trunnion, as used herein, is the ring, wheel, shaft, etc. of a trunnion that rotates. It can be driven or freewheeling.

The system preferably includes a control panel to evaluate sensors for each trunnion. In one embodiment signals from the sensors are indicative of the rotational speed of the trunnion and are compared to the expected rotational speed of the trunnion. This expected speed is often dependent on the particular process or recipe, as well different diameters of a rotational component in the same machine. The preferred embodiment measures wheel rotation and uses the VFD to determine expected wheel rotation. Rotational speed of a trunnion or a pair of trunnions. as used herein, is the rotational speed of the wheel, ring or shaft of the trunnion or pair of trunnions.

When the comparison shows the rotational speed of the trunnion differs or varies from the expected rotational speed for a determined period of time, the control panel creates an alarm. The alarm can be a visible alarm, light (such as flashing a red LED), a negative alarm (such as turning off a green LED), an email, text, or other network or wifi signal (either positive indicating a problem or the absence of a signal indicating no problem), or an auditory alarm (either positive or negative). Alarm, as used herein, is a visual or audible signal such as a light, horn, alpha-numeric messages etc.

The trigger for the alarm can be a threshold difference, a percentage difference, or a function of the difference (the rate of change of the difference, e.g.). Function of the intended rotational speed, as used herein, refers to a function such as percentage or offset. In the preferred embodiment the difference is selected to indicate the trunnion is beginning to fail, to allow time for scheduled replacement instead of a production line shutdown.

Sensors in various embodiments can include embedded bearings and stationary shafts such as a proximity or photo sensor, laser or other appropriate stationary sensor and the corresponding mating flag attached to the rotating trunnion. Trunnions with included shafts, mounted on external bearings could use a similar arrangement with the flag attached to the shaft, or by using a shaft encoder. A flag, as used herein, is a marker on one of a moving or stationary part that is sensed by the other of the moving or stationary part. Stationary mating pickup, as used herein, is a component that detects a flag.

The trunnion monitoring described herein can be used locally on a single system, can be factory installed or retrofitted, can be used to provide remote notifications, and can be part of a complex system including multiple machines at one or more locations. Alternative embodiments include having additional inputs from other sensors to monitor other aspects of the machine's performance. Examples of this would include proper tension of the drive chain, and loads and outputs from the VFDs. The alarm would also be responsive to these additional sensors.

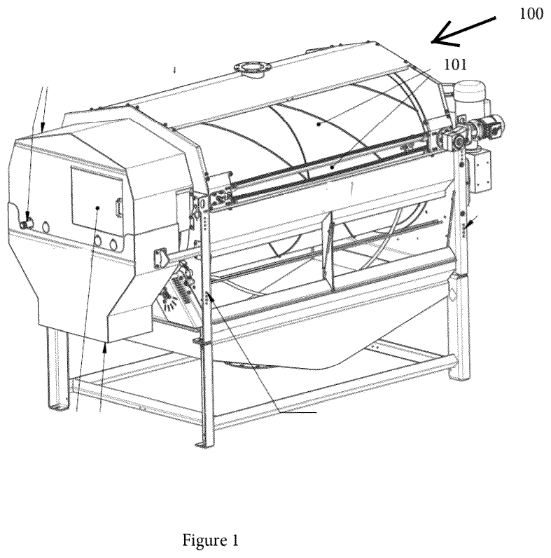

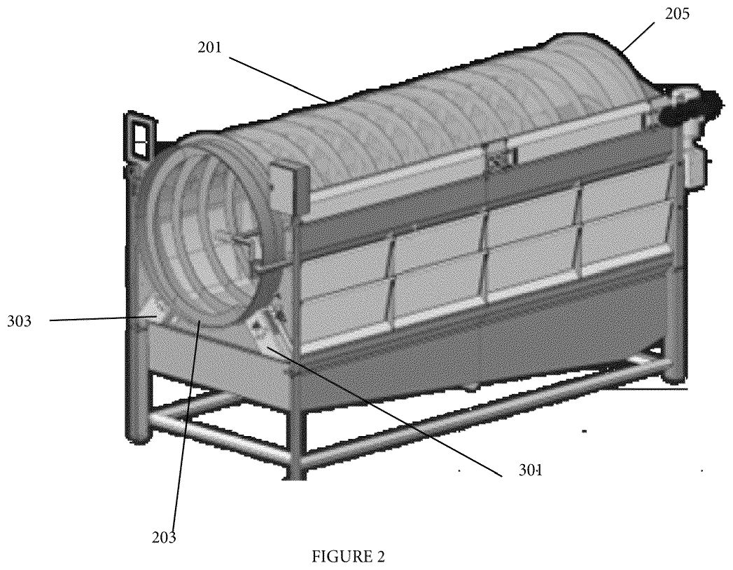

An example of a food processing system in accordance is a food processing water treatment system 100, shown in FIG. 1. System 100 includes a food processing compartment 101. Processing compartment, as used herein, refers to a compartment used for food product water treatment, or used for cooking, cooling or blanching food product. A rotating screen 201 is shown in FIG. 2, which is disposed within compartment 101. Rotating screen 201 has a first input end 203 and a second exit end 205. Water or food product enters system 100 near end 203 and passes through screen 201, while screen 201 captures solids. The captured solids are removed near end 203. Food product, as used herein, includes food (including food in or not in containers) for cooking, cooling or blanching, or water that has been used for cooking, cooling or blanching food. Other embodiments including a rotating component other that screen 201. Rotating component in the compartment, as used herein, is a component of a food processing system that rotates such as an auger or a rotary drum.

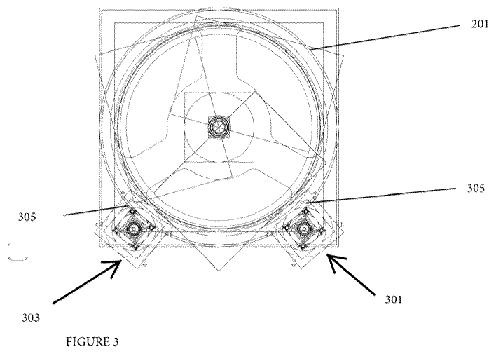

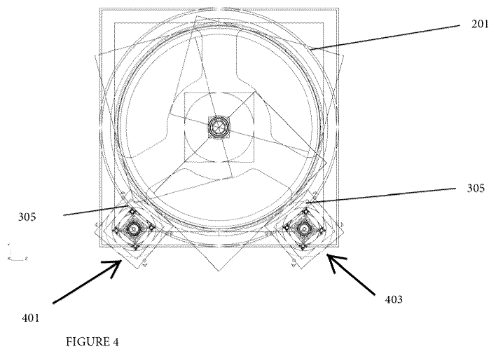

End 203 is rotatably supported by a pair of trunnions 301 and 303, shown in FIG. 3. Rotatably supporting, as used herein, is supporting a shaft, drum, etc in such a way that the shaft, drum, etc can be rotated. End 205 is also supported by trunnions 401 and 403, which are identical to trunnions 301 and 303, as shown in FIG. 4. Trunnions 301, 303, 401 and 403 are not driven trunnions in the preferred embodiment, although they are driven in other embodiments. Another embodiment provides for a one, two or three driven trunnion. Trunnions 301, 303, 401 and 403 includes wheels 305 that are driven and rotate screen 201. In one embodiment the position of trunnions 301, 303, 401 and 403 can be adjustable for cleaning etc.

Trunnions 301, 303, 401 and 403 are identical, and the sensor will be described only with respect to trunnion 301, because the figure would be identical for trunnions 303, 401 and 403. A flag 501 is located on wheel 305 and a mating proximity sensor 503 is located on a stationary portion of trunnion 301. Together the flag and mating sensor are a sensor that senses the rotational speed of trunnions 301, 303, 401 and 403. Alternatives provide for a single sensor on a single trunnion, sensors on both trunnions of one end, sensors on one trunnion ion each end, or sensors on three of the four trunnions. Sensor 501/503 includes a flag on a different rotating component of trunnion 301, 303, 401 and 403 with a stationary mating pickup, and/or an encoder in various embodiments.

Sensor 501/503 provides a signal indicative of the rotational speed of trunnions 301, 303, 401 and 403 to a control panel 511 on a wire 505. Control panel 511 includes an alarm model 513 and an alarm 515. The speed signal is provided to alarm model 513, and alarm model 513 cause alarm 515 to be turned on in response to the rotational speed of the trunnions. Alarm 515 can include separate notifications for each of trunnions 301, 303, 401 and 403, or one notification for all of the trunnions. In one embodiment an alarm 516 is a distinct LED light for each trunnion. In other embodiments it is an audible alarm, a different visual indicator, an alpha-numeric message on a display, or the negative of the above (a light turns of for a display fails to say OK). Alarm 515 is responsive to sensors on each of trunnions 301, 303, 403 and 401.

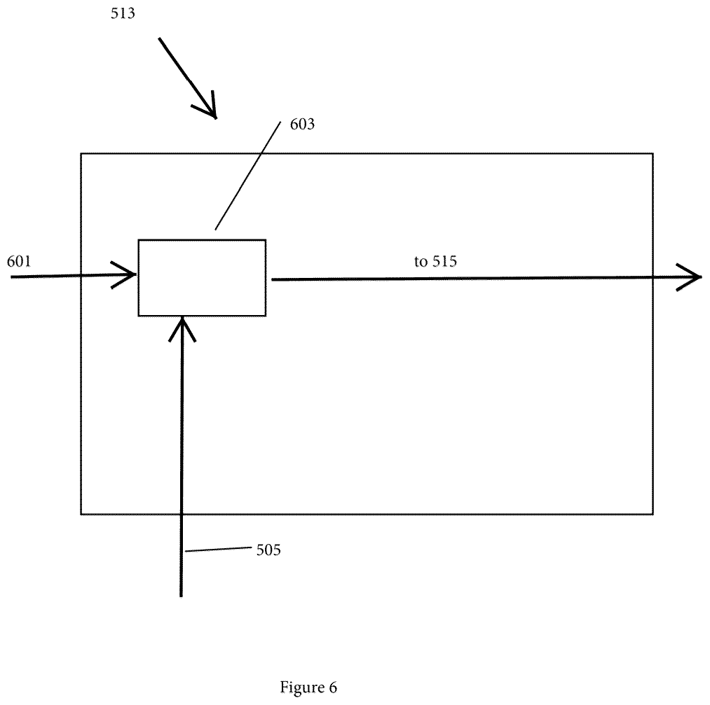

Alarm module 513 includes a signal 601 (FIG. 6) from a trunnion drive (preferably a VFD) indicative of the intended rotational speed of one or more of trunnions 301, 303, 401 and 403. Alarm module 513 includes a comparator 603, which compares the actual sensed speed from wire 505 and the intended speed on 601. When the difference exceeds a threshold in the preferred embodiment, alarm 515 is turned on because that is indicative of a malfunction. In one alternative when the difference exceeds a percentage (or some other function) of the intended speed, alarm 515 is turned on. The preferred embodiment has a trigger for the alarm that is an offset (difference threshold) based on an offset RPM value from the expected RPM. It may be set by the user over a network or at the control panel, and the default threshold is a 5 RPM difference between the intended and sensed speeds. An alternative provides for progressive warnings (the warning increases or repeats as the difference increases). The speed being less than intended, particularly over a period of time, is indicative of wear. By providing the alarm the trunnions can be replaced or repaired at the next scheduled shut down.

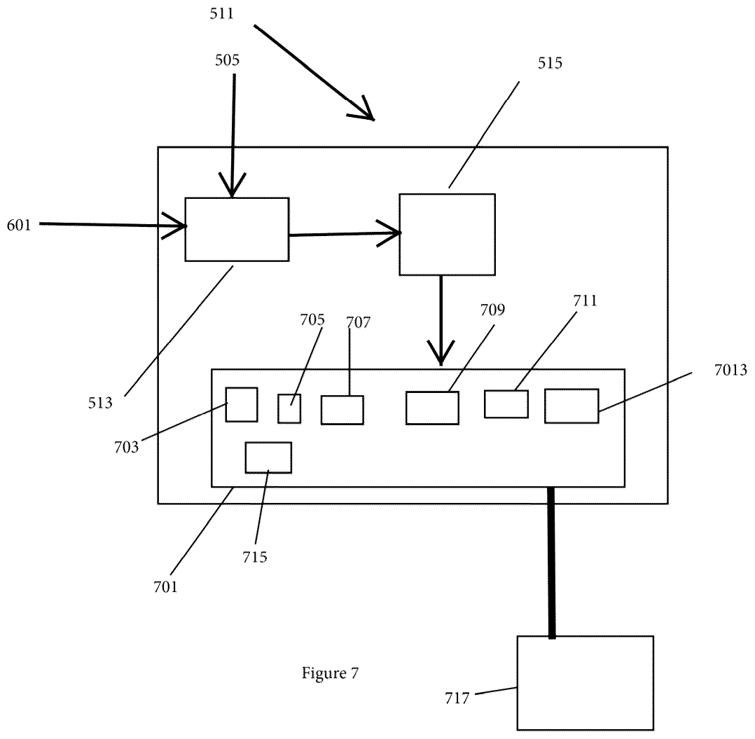

Control panel 511 includes a communications module 701 in the embodiment of FIG. 7. Communications module, as used herein, includes a module that connects to a network or remote location, and includes one or more of wifi, ethernet, etc. Communications module 701 is preferably an off-the-shelf communications module that communicates with industrial standard communications equipment and protocols, and includes one or more of a wifi module 703, an ethernet module 705, an LPWAN module 707, a zigbee module 709, a cellular module 711, a bluetooth module 713, and an RFID module 715. The various modules 703-715 can communicate directly or over a network 717. Other type of modules could be used. Upon receiving a signal indicating the alarm should be provided communications module 701 causes alarm 315 and/or provides a digital signal or message indicating a fault. Digital message, as used herein, includes message with alphanumeric characters such as email, text messages, snap chat messages, postings, whats app messages, etc. In various embodiments the alarm is provided directly or over network 717 to a location remote from the compartment. Location remote from the compartment, as used herein, means a location out of view of a food processing compartment.

Numerous modifications may be made to the present disclosure which still fall within the intended scope hereof Thus, it should be apparent that there has been provided a method and apparatus for processing food with trunnion monitoring that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

1. A food processing system comprising:
a processing compartment, including a rotating component having a first end and a second end;
a first trunnion including a first component for rotational movement and a second trunnion including a second component for rotational movement, wherein the first and second trunnions are disposed to support the first end;
a first sensor disposed to sense a first rotational speed of the first component for rotational movement; and
an alarm responsive to the first sensor.

2. The food processing system of claim 1, further comprising a second sensor disposed to sense a second rotational speed of the second component for rotational movement, wherein the alarm is further responsive to the second sensor.

3. The food processing system of claim 1, further comprising an alarm module including an intended rotational speed of the first one of the first and second trunnions, and wherein the alarm is part of the alarm module, and further wherein the alarm is responsive to a function of the intended rotational speed and to the first sensor.

4. The food processing system of claim 3, wherein the alarm includes a visual indicator.

5. The food processing system of claim 3, wherein the alarm includes a communications module connected to a network, and the visual indicator includes at least one of a light and a digital message.

6. The food processing system of claim 3, wherein the alarm includes a communications module connected to a remote location.

7. The food processing system of claim 1, wherein the first sensor includes a flag on the first component for rotational movement and a stationary mating pickup.

8. The food processing system of claim 1, wherein the first sensor includes an encoder.

9. The food processing system of claim 2, further comprising:
a third trunnion including a third component for rotational movement and a fourth trunnion including a fourth component for rotational movement, wherein the third and fourth trunnions are disposed to support the second end;
a third sensor disposed to sense a third rotational speed of the third component for rotational movement; and
a fourth sensor disposed to sense a fourth rotational speed of the fourth component for rotational movement;
wherein the alarm is responsive to the third sensor and the fourth sensor.

10. A method of processing food, comprising:
providing food product to a processing compartment that includes a rotating component having a first end and a second end;
supporting the first end with a first trunnion including a first component for rotational movement and a second trunnion including a second component for rotational movement;
rotating the first component at a first rotational speed;
sensing the first rotational speed of the first component; and
providing an alarm in response to the first rotational speed indicating a malfunction of the first trunnion.

11. The method of claim 10, further comprising:
rotating the second component at a second rotational speed;
sensing the second rotational speed of the second component; and
providing an alarm in response to the second rotational speed indicating a malfunction of the second trunnion.

12. The method of claim 11, wherein providing the alarm includes providing the alarm in response to one of the second rotational speed being non-zero and less than a desired rotational speed and the first rotational speed being non-zero and less than the desired rotational speed.

13. The method of claim 12, wherein providing the alarm includes providing at least one of a light and a digital message.

14. The method of claim 13, wherein providing the alarm includes providing a visual indicator at a location remote from the compartment.

15. The method of claim 13, wherein sensing includes a sensing a flag on the first component.

16. The food processing system of claim 13, further comprising:
supporting the second end with a third trunnion including a third component for rotational movement and a fourth trunnion including a fourth component for rotational movement;
rotating the third component at a third rotational speed;
sensing the third rotational speed of the third component;
rotating the fourth component at a fourth rotational speed;
sensing the fourth rotational speed of the fourth component; and
providing the alarm in response to the third rotational speed indicating a malfunction of the third trunnion
providing the alarm in response to the fourth rotational speed indicating a malfunction of the fourth trunnion.

17. An apparatus for processing food, comprising:
a processing compartment, including a rotating component having a first end and a second end;
a first support means for rotatably supporting the first end;
means for sensing a first rotational speed of the first support means;
alarm means, connected to the means for sensing, for providing an alarm in response to the first rotational speed indicating a malfunction of the first support means.

18. The apparatus of claim 17, further comprising:
a second support means for rotatably supporting the second end;
means for sensing a second rotational speed of the second support means;
second alarm means, connected to the means for sensing the second rotational speed, for providing a second alarm in response to the second rotational speed indicating a malfunction of the second support means.

19. The apparatus of claim 17, wherein the alarm means is further for providing an alarm in response to the first rotational speed indicating the first rotational speed being non-zero and less than a desired rotational speed.

20. The apparatus of claim 19, wherein the alarm means includes a visual indicator.

21. The apparatus of claim 20, wherein the alarm means includes means for providing at least one of a light and a digital message a location remote from the compartment.

22. The apparatus of claim 20, further comprising:
a second support means for rotatably supporting the second end;
means for sensing a second rotational speed of the second support means;
wherein the alarm means is further connected to the means for sensing a second rotational speed and is further for providing an alarm in response to the second rotational speed indicating a malfunction of the second support means.
